(19) United States
(12) Patent Application Publication
(10) Pub. No.: US 2026/0286884 A1
(43) Pub. Date: Sep. 24, 2026

(54) PRESSURE-APPLIED CAP FOR VEHICULAR SYSTEM

(71) Applicant: MUVIQ S.R.L., Ivrea (IT)

(72) Inventors: Gianluca CARICCIA, SAN BERNARDO D'IVREA (IT); Andrea GUALA, SAN BERNARDO D'IVREA (IT); Antoni PORCEL, SAN BERNARDO D'IVREA (IT); Stefan BRANDIN, SAN BERNARDO D'IVREA (IT); Jacopo SPINELLI, SAN BERNARDO D'IVREA (IT)

(73) Assignee: MUVIQ S.R.L., Ivrea (IT)

(21) Appl. No.: 18/874,159

(22) PCT Filed: May 24, 2023
(86) PCT No.: PCT/IB2023/055343

§ 371 Date: Dec. 12, 2024

(30) Foreign Application Priority Data
Jun. 15, 2022 (IT) 102022000012698

(51) Int. Cl. F02B 77/00; B32B 1/00; B32B 3/04; B32B 3/10; B32B 15/088; B32B 15/18; B32B 15/20

(52) U.S. Cl. CPC F02B 77/005; B32B 1/00; B32B 3/04; B32B 3/10; B32B 15/088; B32B 15/18; B32B 15/20; B32B 2435/00; B32B 2605/00

(57) ABSTRACT

A pressure-applied cap for a vehicular system has a first metal layer and a second polyamide layer in direct contact with the first metal layer and entirely covering the first metal layer. The pressure-applied cap has a weakened portion configured to break under the action of a predetermined force.

### CROSS-REFERENCE TO RELATED PATENT APPLICATIONS

This patent application relates to Italian patent application No. 102022000012698 filed on Jun. 15, 2022 the entire disclosure of which is incorporated herein by reference.

### TECHNICAL FIELD

The present invention concerns a cap, in particular a pressure-applied cap for a vehicular system.

The present invention is preferably, although not exclusively, applied in elements of vehicular systems having the function of closing openings where it is necessary to prevent the entry of contaminants and/or the leakage of fluids contained in said elements. Said application will be referred to below by way of example.

### STATE OF THE ART

The use of pressure-applied caps to close openings made in vehicular systems is known. An example of said cap in the state of the art is illustrated in EP3033505 A1.

As illustrated in the cited publication, the cap is press-fitted in an opening of the vehicular system of a vehicle, such as an engine system. Said caps have a high resistance to the vehicular operating temperatures and pressures and at the same time are particularly rigid and also biocompatible.

However, once fitted, the caps of the type illustrated are difficult to remove in order to gain access to the engine system through the opening for maintenance or inspection.

The need is therefore felt to facilitate the removal of a cap of the above-mentioned type without compromising the excellent properties described above during standard operation thereof.

The object of the present invention is to meet the above needs in an optimised and inexpensive manner.

### SUMMARY OF THE INVENTION

The above-mentioned object is achieved by a cap and a vehicular system as claimed in the attached claims.

### BRIEF DESCRIPTION OF THE DRAWINGS

For a better understanding of the present invention, a preferred embodiment is described below by way of non-limiting example and with reference to the attached drawings in which:

FIG. 1 is a lateral schematic view of an engine system provided with caps according to the invention;

FIG. 2 is a diametral section view of a cap according to the invention; and

FIGS. 3 and 4 are respective perspective views from above and below of a cap according to the invention.

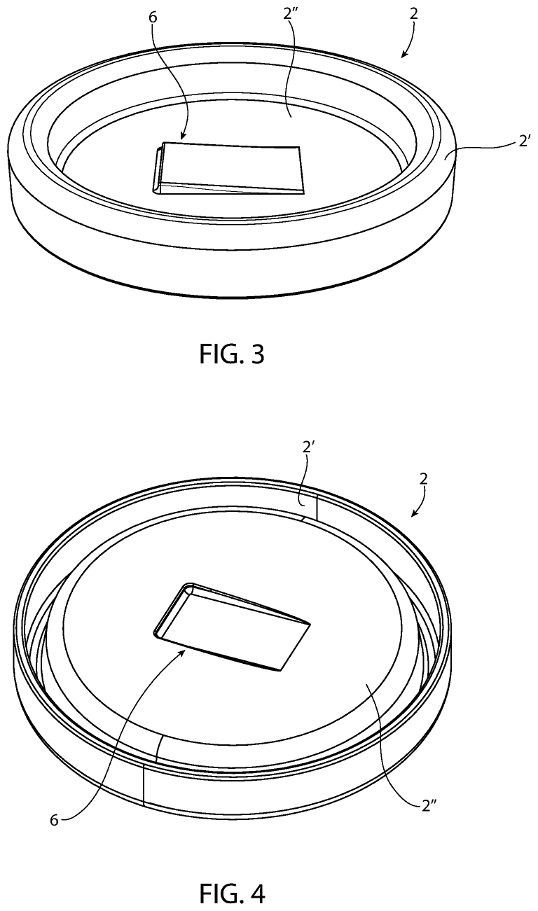

### DETAILED DISCLOSURE OF THE INVENTION

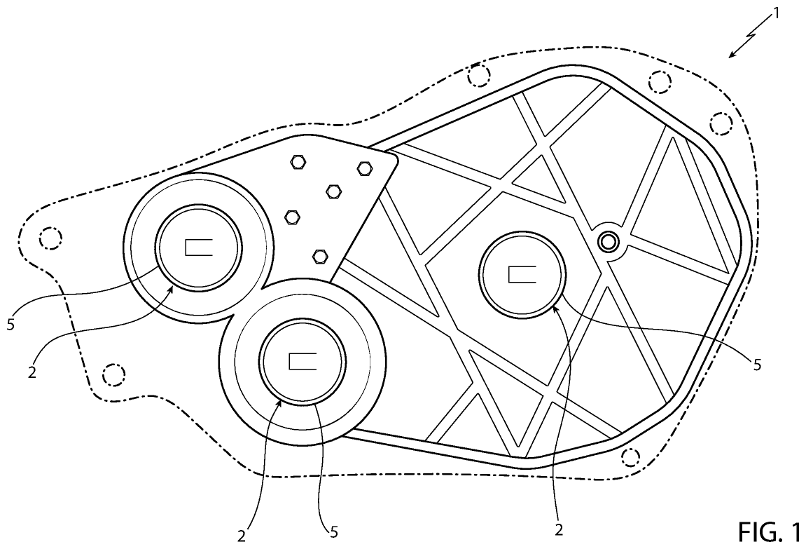

FIG. 1 illustrates a vehicular system 1 of a vehicle, for example an engine casing.

The vehicular system 1 comprises, in the embodiment illustrated, a plurality of rigid pressure-applied caps 2 according to the invention. Below, the expression “rigid pressure-applied cap” will be replaced by “cap” or “pressure cap” for the sake of brevity.

As illustrated in the figures from 2 to 4, the pressure cap 2 comprises a first structural layer 3, made of metal material, and a second protective layer 4, made of polyamide.

Advantageously, the second layer 4 is located externally to the first layer 3 so that the latter is contained inside it, in direct contact. Preferably, the entire first layer 3 is entirely surrounded by a second layer 4 throughout the surface thereof.

Advantageously the polyamide of the second layer 4 is a biopolyamide, preferably derived from castor oil, such as PA11. More preferably, it is a biopolyamide of the family sold under the brand RILSAN.

In detail, the second layer is made over 50% of polyamide, advantageously over 80%, and even more preferably is made entirely of polyamide.

Advantageously, the thickness of the first layer 3 ranges from 0.5 to 2 mm, preferably from 0.75 mm to 1.5 mm, while the second layer 4 has a thickness ranging from 0.15 mm to 0.3 mm, preferably from 0.2 to 0.3 mm.

The first layer 3 is advantageously made of steel or cast iron or aluminium.

The pressure cap 2 can be made according to the procedure illustrated in the cited publication EP3033505 A1 and not reported for the sake of brevity.

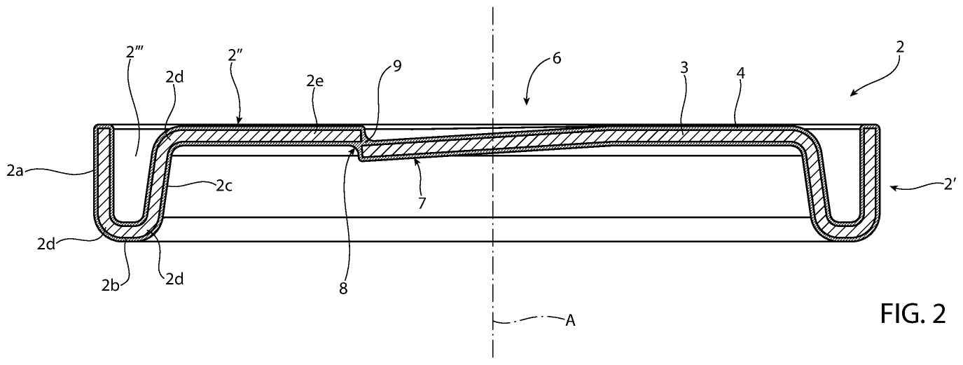

As can be seen better in FIG. 2, the pressure cap 2 comprises a coupling portion 2′ configured to cooperate with an opening 5 of the vehicular system 1 and an intermediate portion 2″ radially included by the coupling portion 2′.

In particular, the coupling portion 2′, in the embodiment described, has a circular annular shape and the intermediate portion 2″ has a circular disc shape.

Consequently, the coupling portion 2′ extends about an axis A which is, in use, advantageously coaxial with the axis of the opening 5.

In detail, the coupling portion 2′ comprises an axial wall 2a configured to cooperate in contact with a wall of the above-mentioned opening 5 and therefore extending parallel to the axis A, a radial wall 2b extending from one end of the axial wall 2a and an inclined wall 2c extending from the radial wall 2b, on the opposite side with respect to the axial wall 2a and directed towards the opposite end with respect to the radial wall 2b.

In the embodiment described, the inclined wall 2c extends in a tapering manner so as to reduce its distance from the axis A moving away from the radial wall 2b.

In particular, the axial wall 2a, radial wall 2b and inclined wall 2c are connected to one another by means of curved portions 2d with predefined radius.

According to the geometry described above, a space 2′″ is therefore present radially comprised between the axial wall 2a and the inclined wall 2c and axially delimited, on one side, by the radial wall 2b and open on the opposite side.

The intermediate portion 2″ comprises essentially a single wall 2e which is connected to the inclined wall 2c; preferably it is connected to the inclined wall 2c by means of a curved portion 2d.

The above-mentioned curved portions 2d are advantageously made with the same radius of curvature.

In particular, the single wall 2e is substantially positioned at the same height as the end of the axial wall 2a opposite to the radial wall 2b.

The pressure cap 1 advantageously comprises a weakened portion 6 configured to break under the action of a predefined force. For example, said predefined force can be provided by a tool such as a screwdriver or a specific device adapted for the purpose, such as a hook element.

Preferably, the weakened portion 6 is made in the intermediate portion 2″. Advantageously, the weakened portion 6 is made as a lowered portion 7 in the intermediate portion 2″, namely in the single wall 2e.

Preferably the lowered portion 7 is substantially centred with respect to the intermediate portion 2″ and, according to the embodiment illustrated, is rectangular.

In detail, the weakened portion 6 defines a cut 8 with respect to the first layer 3 defining the intermediate portion 2″, namely the single wall 2e. In other words, two portions of the first layer 3 are separated from each other by a cut 8. In particular, said cut 8 is made in the deepest portion of the lowered portion 7 with respect to the single wall 2e.

In particular, according to the embodiment described, said cut 8 is made on one of the sides of the rectangle, preferably on one of the smaller sides of the rectangle.

The cut 8 is occupied entirely by the second layer 4 which makes a bridge portion 9 between the two parts separated by the cut 8 of the first layer 3.

The dimensions and the shape of the cut 8 and of the bridge 9 can vary according to the dimensions and type of the pressure cap 1 required.

Operation of the embodiment of the pressure cap 1 according to the invention described above is as follows.

In an operating condition, the cap 1 is press-fitted in the opening 5, namely so that a force is exerted between the axial wall 2a and the opening 5. Said force is guaranteed by the “spring” effect provided by the inclined wall 2c which can be compressed according to the interference between opening 5 and axial wall 2a.

If it is necessary to remove the cap 1 from the opening 5, the user can perforate the cap 1 by acting on the weakened portion 6. In particular, the user can act on the short side which is deeper than the single wall 2e which is made substantially only by the second layer 4 and is therefore less strong. Once penetrated by means of a suitable tool, such as a hook or a screwdriver, the cap can be easily removed thanks to the lever acting between the insertion point of the tool and the axial wall 2a.

From the above, the advantages of a pressure cap according to the invention are evident.

Thanks to the weakened portion, it is possible to easily remove the pressure cap once fitted in the opening without harming the structural, thermal and chemical/physical resistance thereof.

In particular, the provision of the intermediate portion of the cap in a specific lowered, visually identifiable point allows easy identification by the user who can easily remove it by exerting a reduced force and with the help of a suitable tool, such as a hook or a screwdriver.

In fact, the presence of the first metal layer and the second polyamide layer ensures the known properties of resistance to high temperatures, to thermal shocks and to the operating pressures of the above-mentioned vehicular applications.

Furthermore, polyamide is a very environmentally friendly compound.

Lastly, it is clear that modifications and variations can be made to the pressure cap according to the present invention which do not depart from the protective scope defined by the claims.

For example, the forms described and the ranges reported can vary with respect to the description, within the limits of the claims.

1. A pressure-applied cap for a vehicular system, said cap comprising:
a first metal layer;
a second polyamide layer in direct contact with said first metal layer and entirely covering said first metal layer; and
a weakened portion configured to break under the action of a predetermined force.

2. The pressure-applied cap according to claim 1, wherein said cap comprises a coupling portion configured to press-fit into an opening of said vehicular system and extending about an axis (A) and an intermediate portion radially included by said coupling portion, said weakened portion being made in said intermediate portion.

3. The pressure-applied cap according to claim 2, wherein said weakened portion comprises a lowered portion.

4. The pressure-applied cap according to claim 2, wherein said weakened portion comprises a cut between two portions of said first metal layer, said cut being occupied by said second polyamide layer.

5. The pressure-applied cap according to claim 3, wherein said lowered portion has a rectangular shape.

6. The pressure-applied cap according to claim 5, wherein said weakened portion comprises a cut between two portions of said first metal layer, said cut being occupied by said second polyamide layer, and wherein said cut is made in one of the smaller sides of said lowered portion having a rectangular shape.

7. The pressure-applied cap according to claim 3, claims, wherein said lowered portion is centred with respect to said axis (A).

8. The pressure-applied cap according to claim 1, wherein said first layer is made of steel, cast iron or aluminium.

9. The pressure-applied cap according to claim 1, wherein said second layer comprises at least 50% polyamide.

10. The pressure-applied cap according to claim 1, wherein said second layer comprises at least 80% polyamide.

11. The pressure-applied cap according to claim 1, wherein said second layer is made entirely of polyamide.

12. The pressure-applied cap according to claim 2, wherein said coupling portion comprises an axial wall configured to cooperate in contact with said opening, a radial wall extending from one end of said axial wall and an inclined wall extending from said radial wall from opposite side of said axial wall and cooperating with said intermediate portion.

13. The pressure-applied cap according to claim 12, wherein said intermediate portion comprises a single wall.

14. The pressure-applied cap according to claim 13, wherein said walls are connected by connecting portions said connecting portions defining a same radius of curvature.

15. (canceled)

16. A vehicular system comprising:
an engine system having an opening configured to receive a cap; and
a pressure-applied cap seated in closing engagement with the opening, the pressure applied cap comprising:
a first metal layer;
a second polyamide layer in direct contact with said first metal layer and entirely covering said first metal layer; and
a weakened portion configured to break under the action of a predetermined force.

17. The pressure-applied cap according to claim 16, wherein said cap comprises a coupling portion configured to press-fit into an opening of said vehicular system and extending about an axis (A) and an intermediate portion radially included by said coupling portion, said weakened portion being made in said intermediate portion.

18. The pressure-applied cap according to claim 16, wherein said weakened portion comprises a cut between two portions of said first metal layer, said cut being occupied by said second polyamide layer.

19. The pressure-applied cap according to claim 18, wherein said cut is made in one of the smaller sides of said lowered portion having a rectangular shape.

20. The pressure-applied cap according to claim 16, wherein said weakened portion comprises a lowered portion that has a rectangular shape and is centred with respect to said axis (A).

21. The pressure-applied cap according to claim 16, wherein said first layer is made of steel, cast iron or aluminium and said second layer comprises at least 50% polyamide.
